(19) United States
(12) Patent Application Publication
(10) Pub. No.: US 2018/0041632 A1
(43) Pub. Date: Feb. 8, 2018

(54) CUSTOMIZABLE PRESENCE-BASED RECIPIENT AVAILABLE NOTIFICATION

(71) Applicant: Polycom, Inc., San Jose, CA (US)

(72) Inventors: Pramod Peethambaran, Hyderabad (IN); Mukul Sukhlecha, Bhilwara (IN)

(21) Appl. No.: 15/668,076

(22) Filed: Aug. 3, 2017

(30) Foreign Application Priority Data
Aug. 8, 2016 (IN) 201631 027043

(51) Int. Cl. H04M 3/42; H04M 3/424

(52) U.S. Cl. CPC H04M 3/42374; H04M 3/424; H04M 3/42195

(57) ABSTRACT

A telecommunication device featuring customizable, presence state-based recipient availability notification alerts a call initiator that a call target having an initially unavailable presence state has become available as indicated by the current presence state of the target. An option to initiate a call is then presented to the call initiator.

### RELATED APPLICATIONS

This application claims priority under 35 U.S.C. §119 to Indian Patent Application No. 201631 027043 filed on Aug. 8, 2016, the entire content of which is hereby incorporated by reference.

### BACKGROUND

The present disclosure relates generally to telecommunication systems, and more particularly, to customizable presence state-based recipient availability notification.

Telephones and conference systems are fairly universal business communications tools. Modern digital telecommunication systems enable transfer of a large and varied amount of audio and video data over private and public data networks. Digital phones also enable a wealth of user features, including digital directories, call routing, conference calls, digital voicemail, caller identification, etc.

Some digital telecommunication devices are enabled to have a “presence state” setting that indicates whether the device—and by association the user of the device—is available or unavailable. Such presence states may include, for example, “available,” “on a call,” “in a meeting,” “out of office,” or “do not disturb.” Presence state settings may be automatic, such as “on the phone” when the phone is in use, or set by a user of the device, such as “do not disturb.” The presence state setting may be associated with certain phone behaviors, such as not permitting the receipt of phone calls or sending incoming calls directly to voicemail. In some cases, the presence state of a receiving phone is visible to other telecommunication devices on the telecommunication network, so that users who wish to contact a call receiver are notified of the receiver's current availability via the indicated presence state. When the intended receiver of a call is unavailable, a caller must either wait until the call receiver returns a missed call or responds to voicemail, or the caller must monitor the call receiver's presence state to determine when the call receiver becomes available to receive a call.

For some PBX systems a user can get an option to have the PBX ring an intended receiver of a call when the intended receiver finishes a current call. But such PBX systems are limited to phones connected to or routed through the PBX and the only option is callback when the call is completed. If the intended receiver becomes unavailable for any reason, the PBX will be unaware and will still perform the callback, even though the intended recipient is not actually available. There have also been discussions on how this simple callback scenario can be performed on Session Initiation Protocol (SIP)-based phones. But one problem with this basic function in either case is that the original caller may not be ready when the system performs the callback, even though he may be present. This would result in a communication that is less pleasant than desirable.

### SUMMARY

Customizable, presence-based recipient availability notification for telecommunication devices is disclosed. In one aspect, upon notification that a previously unavailable call target has become available, a user is provided with the option of initiating a phone call to the now-available call target. For example, a caller (“call initiator”) initiates a call to a call receiver (“call target”) identified by the call initiator, for example, by a phone number. If the call target is in the “available” presence state, then the call will be initiated immediately. If the call target is in an unavailable presence state, then at a later time—when the call target's presence state changes to the “available” presence state—the call initiator is notified that the call target is now available. In an embodiment, notification is generated via the call initiator phone's display. In another embodiment, the notification is generated by sending a message to a third device designated by the call initiator. In an embodiment, an option for the call initiator to choose to initiate a call to the call target now that the call target is available is provided. Selection of the callback option may be received, for example, via selection of a soft or hard button by the call initiator. In another embodiment, the option to call may be selected by receiving a response from the call initiator, for example “yes” or “initiate call.”

### BRIEF DESCRIPTION OF THE DRAWINGS

FIG. 1 is a flow chart illustrating a method for presence state-based recipient availability notification, according to an embodiment of the invention.

FIG. 2 is a flow chart illustrating methods for presence state-based recipient availability notification incorporating monitoring the presence state of a call target, according to an embodiment of the invention.

FIG. 3 is a flow chart illustrating methods for presence state-based recipient availability notification incorporating a request for availability notification from the call target, according to an embodiment of the invention.

FIGS. 4A and 4B illustrate views of a telecommunication device having a display displaying a presence state-based notification, according to an embodiment of the invention.

FIG. 5 illustrates a system diagram of a telecommunication device featuring presence state-based recipient availability notification, according to an embodiment of the invention.

### DETAILED DESCRIPTION

The following description is made for the purpose of general illustration and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

A customizable, presence state-based recipient availability notification feature of a telecommunication device allows a caller (“call initiator”) to choose whether or not to initiate a call when a previously unavailable call target becomes available. The target telecommunication device, for example a desktop telephone, is enabled to have an associated presence state. Presence states designate whether the device is available or unavailable. Examples of unavailable presence states may include “out of office,” “in a meeting,” “on the phone,” or “do not disturb.” The presence state of a phone may be correlated with phone behaviors, such as sending incoming calls straight to voice mail, forwarding calls, or refusing calls. The presence state may be determined automatically by the target telecommunication device. For example, the presence state may be set to “on the phone” when the phone is in use. Or, the presence state may be manually selected by a user. For example, the user may set the presence state to “do not disturb” if he does not wish to take calls while in the office. In another alternative, the presence state may be set by software. For example, the target phone may be programmed to be in an “out of office” presence state outside of business hours and/or during the lunch hour. Or, the target device may be in communication with a scheduler or calendar so that the device presence state reflects events logged in the schedule or calendar, such as “in a meeting.”

The presence state of a telecommunication device may be “visible” to other telecommunication devices. Visibility may be limited to other devices on a closed network, or unlimited and generally available to a public network. Visibility of a device's presence state may also be limited to a subset of networked devices having appropriate permissions. As such, where a call target is unavailable at the time of call initiation, the presence state of the call target device may be monitored until it becomes available. Upon becoming available, the call initiator may be notified by one or more actions. The user is then provided with the option of initiating a phone call to the now-available call target.

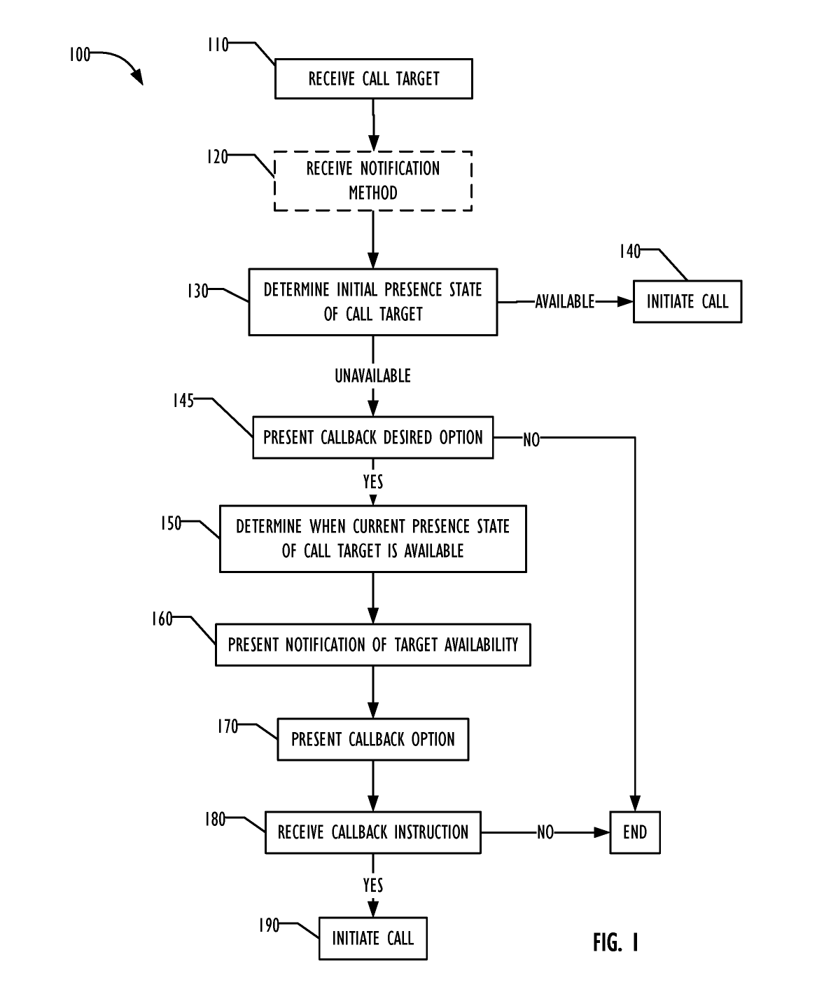

FIG. 1 illustrates a method 100 for customizable, presence state-based recipient availability notification, according to an embodiment of the invention. The method may be executed by a processor located within an initiating telecommunication device, by a remote processor in communication with the telecommunication network, or by a combination of a local and remote processor. In block no, a call target is received. The call target may be specified by a corresponding unique identifier, such as a telephone number or network extension. A user may, for example, initiate a phone call by dialing a phone number indicating a call target. Or, the user may select a call target from a directory accessed via the initiating phone.

At block 120, the notification method is optionally specified, according to an embodiment. The notification method may include, for example, displaying the notification on a display on the call initiator telephone or an affiliated display such as a desktop, or sending a “missed call” notification, whereby a missed call from the previously unavailable call target identifier (e.g. phone number) indicates that the previously unavailable call target is now available. Other methods of notification are possible.

At block 130, the initial presence state of the call target is determined, according to an embodiment of the invention. As discussed above, the presence state of a target device is “visible” to one or more other telecommunication devices via a telecommunication network. As such, an initiating phone may query the target device directly in order to determine the presence state of the target device. In another embodiment, a remote processor includes storage for storing the current presence state of telecommunication devices with which the processor is networked. The remote processor may monitor the presence state of the networked devices by querying the devices or by receiving updates from each device as a presence state changes. In yet another embodiment, a remote processor queries the target phone based on an instruction from the initiating device.

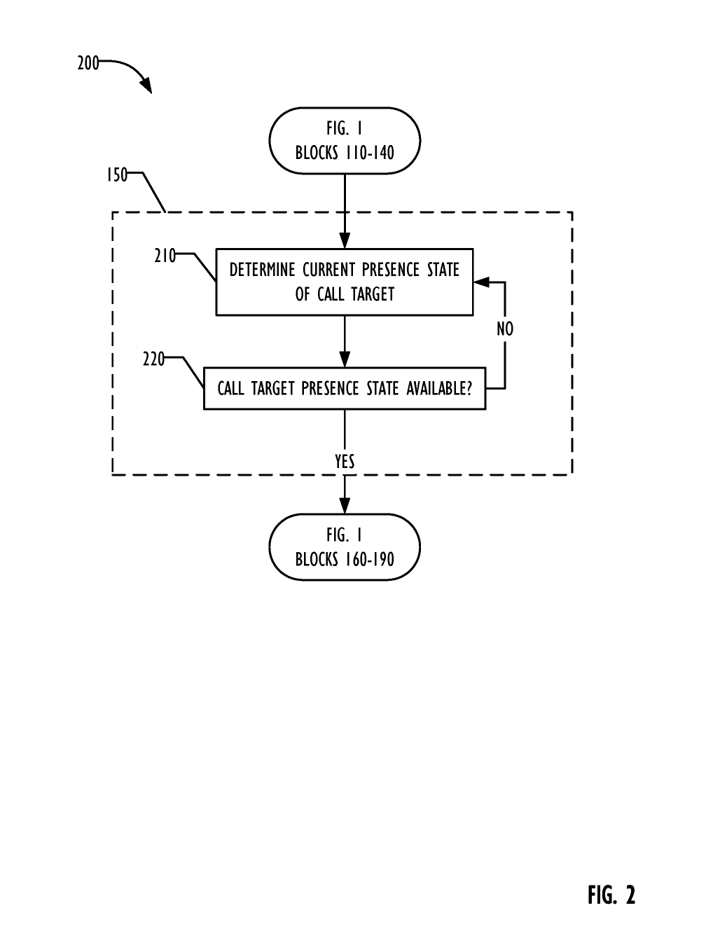

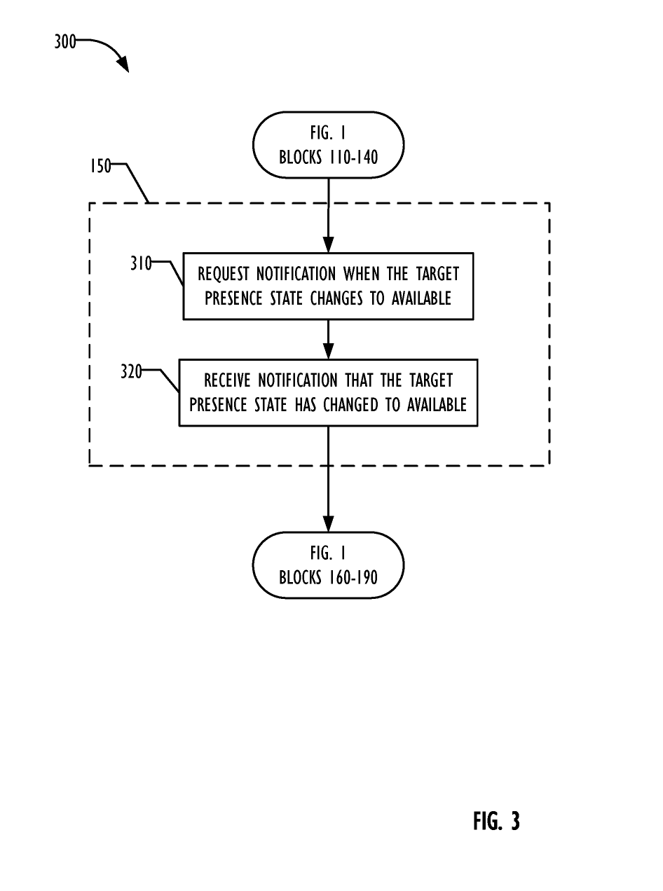

If the target presence state is available, then the phone call is initiated, as shown in block 140. If the target presence state is unavailable, then the user may be presented with the option of activating a callback option in step 145. If the user indicates no callback is desired, the call ends. If the user indicates a callback is desired, the method proceeds to block 150, where it is determined when the target presence state is available. Two different embodiments for determining that the call target presence state is available is described in more detail with respect to FIGS. 2 and 3.

FIG. 2 illustrates a method 200 for customized, presence state-based recipient availability notification, where the presence state of the target phone is monitored, according to an embodiment of the invention. The method includes blocks 110-190, as shown in and described with respect to FIG. 1. Block 150 is expanded to show an embodiment for determining when the current presence state of call target is available. The monitoring steps include blocks 210 and 220. In block 210, the current presence state of the call target is determined. In block 220, the current presence state is evaluated to determine if it is an available state. If the presence state is available, then the method proceeds to notification and callback options. If the presence state is not available, then the current presence state of the call target is redetermined. The current presence state may be redetermined one or more times, checking until the presence state has changed to an available presence state.

In an embodiment, there is a time limit associated with the monitoring the presence state of the call target. The presence is monitored for a set period of time, and if the presence state of the call target does not change to available within the time period, then the process terminates. The time period may be a default time period or customizable by a user. In addition, the time period may vary between unavailable presence states. For example, if the presence state is “on the phone,” then the time period may be 10 minutes. But if the presence state is “in a meeting”, then the time period may be 30 minutes.

FIG. 3 illustrates a method 300 for customized, presence state-based recipient availability notification, where the initiating phone requests notification from the target phone when the target phone's presence state becomes available, according to an embodiment of the invention. The method includes blocks 110-190, as shown in and described with respect to FIG. 1. Block 150 is expanded to show an embodiment for determining when the current presence state of call target is available. The requesting steps include blocks 310 and 320. If the initial presence state of the call target is unavailable, then the current presence state of the call target is determined by requesting notification from the call target when the current presence state changes. In block 310, a request is sent for notification when the call target is available, according to an embodiment. At block 320, a notification is received that the call target is in an available presence state. By requesting and receiving notification that the call target is in the available presence state, the processor executing the method (e.g. by a processor located in the initiator phone or in a server on the communication network) does not have to monitor the call target, as discussed with respect to FIG. 2. In an embodiment, the target phone has the capability both to receive requests and send notifications of a change in presence state. In another embodiment, a remote processor located on the communication network receives the request and sends the notification. For example, the initiating phone may send the request for notification when the call target is available to the remote server. The remote server may then either monitor the call target for a presence state change, or it may request and receive a notification from the target phone. In another example, the remote server may send the request for notification to the call target.

Returning to block 160, once the call target has been determined to be available, then a notification is presented, according to an embodiment. Notification may be performed by a variety of methods. In an embodiment, a notification is displayed on a display affiliated with the call initiating device. The notification visually indicates that the previously unavailable call target is available, according to an embodiment. Examples of notifications include a written message, and a graphic indicator. Other types of notification are possible. A notification may be displayed on a display associated with the initiating device, such as a display on the initiating device or the display of a computer associated with the initiating device.

In another embodiment, notification is sent in the form of a “missed call.” A missed call may appear to the initiating caller as if the initiating caller has missed a call from the target caller, though a call has not actually been initiated from the target phone to the initiating caller. The appearance of a missed call from the call target indicates to the call initiator that the target phone is now in an available presence state, so that the call initiator may initiate a call to the call target. In an embodiment, the call initiator may have the option of specifying the phone number to which the missed call should be sent. For example, this allows a user who initiates a call to an unavailable call target from a desktop phone to specify that the missed call signaling the availability of the call target should be sent to a cell phone number, as opposed to the number of the initiating phone.

It is to be understood that the recipient availability notification system may be customized to perform more than one notification action when the presence state of a target device changes from an initial presence state to an available presence state. For example, once it is determined that the target has an available presence state, then both the actions of sending a missed call to a mobile device and displaying a notification on the initiating phone's display may be performed.

At block 170, a callback option is presented, according to an embodiment. The callback option may be presented alongside the notification of call target availability. In an embodiment, the option to initiate call to the now-available call target is presented. In another embodiment, the presented options include the option to ignore the notification (i.e. not initiate a call to the available call target) and “snooze”, whereby notification is re-presented after a period of time, along with the option to initiate a call to the available call target.

At block 180, a callback instruction is received, according to an embodiment. The callback instruction may be input, for example, by selection of a hard button on the telephone device, as a click or touch of a soft button on a display, or as a text response from a mobile device. If the callback instruction indicates that a call should be initiated, then the call is initiated, at block 190. If the callback instruction indicates that no call should be initiated, then the method terminates.

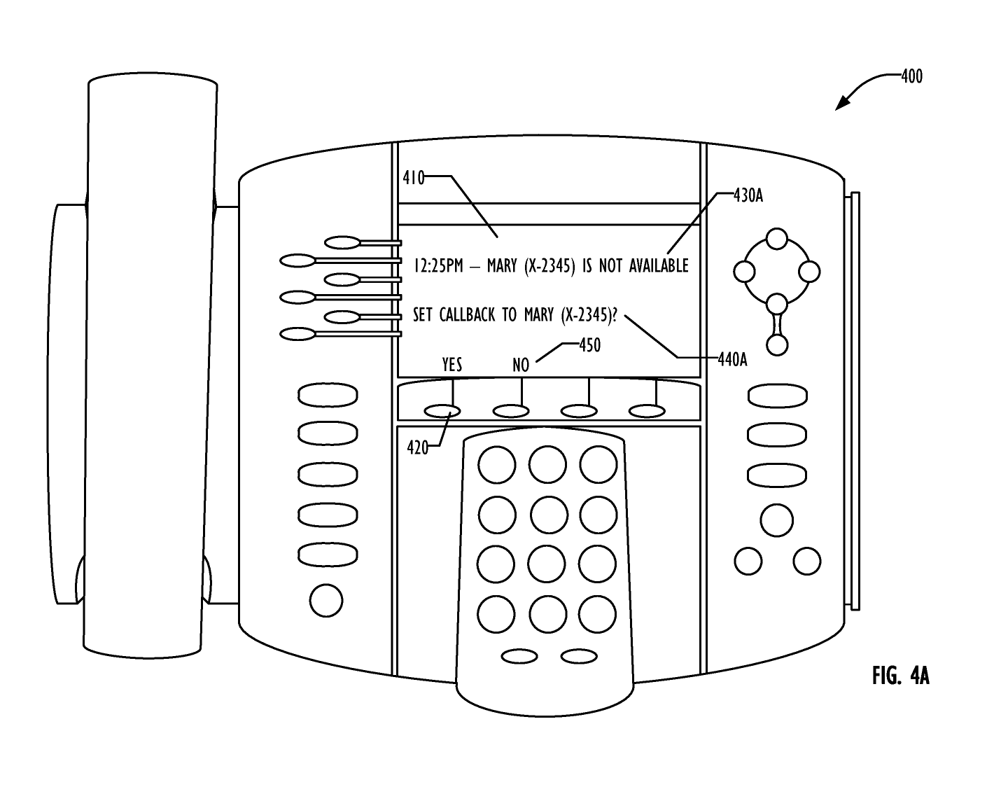

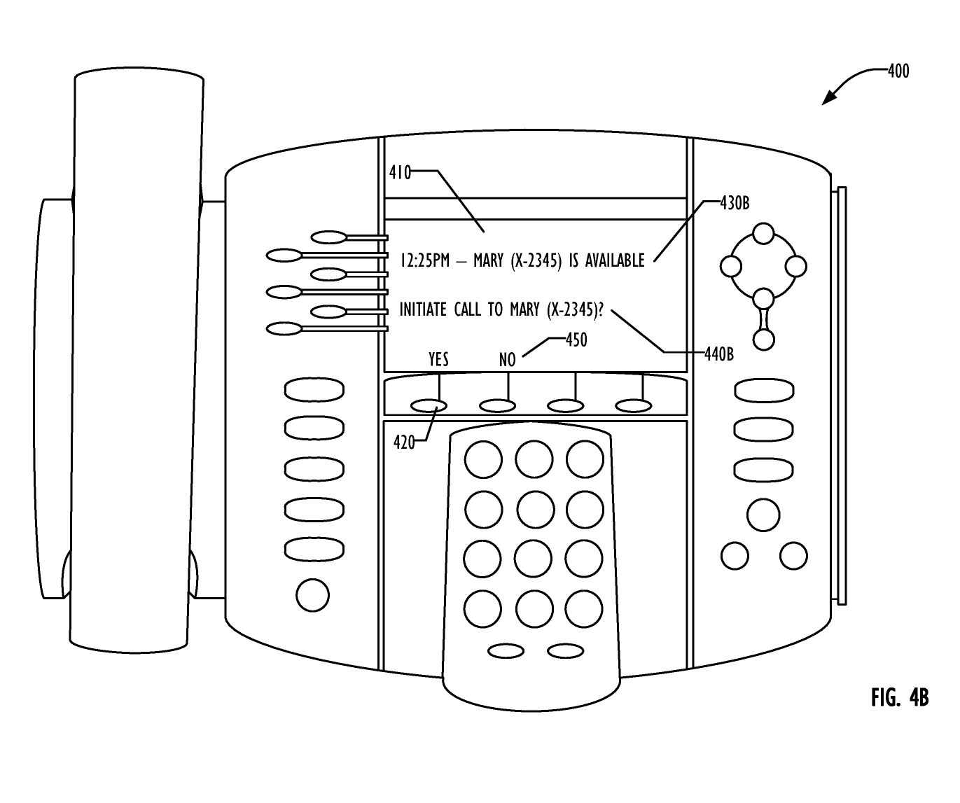

FIGS. 4A and 4B illustrate a telecommunication device 400 having a display 410 for displaying a presence state-based notification, according to an embodiment of the invention. In an embodiment, device 400 is the call initiating device. A user of initiating device 400, at some past time, has attempted to initiate a call to Mary at extension “X-2345”. At the earlier time, the presence state of Mary's phone was determined to be in an unavailable state, so a call was not initiated at that time but a notification 430A is made indicating the unavailability. An option 440A is presented requesting whether the user desires to activate the callback function. In an embodiment the user selects “Yes.” Then, at 12:25 PM, the presence state of Mary's phone was determined to be “available.” In an embodiment, notification 430B is displayed on display 410 of call initiating device 400, stating that Mary is now available. Notification may also be displayed on other types of displays, such as a desktop computer display, a laptop display, a tablet, or a mobile device.

Callback option 440B is provided, requesting input from the call initiator as to whether the call initiator desires to initiate a call to Mary, now that she is available. In an embodiment, input options 450 “Yes” and “No” are provided. Other options may be provided, for example, “remind me later.” Input of selection of an input option may be received by a variety of methods. In an embodiment, one of buttons 420 corresponding to input options 450 is selected by a user to input a selection. In another embodiment, a user interface may allow input selection by clicking a soft button, for example using a finger on a touch screen or with a mouse on an affiliated display.

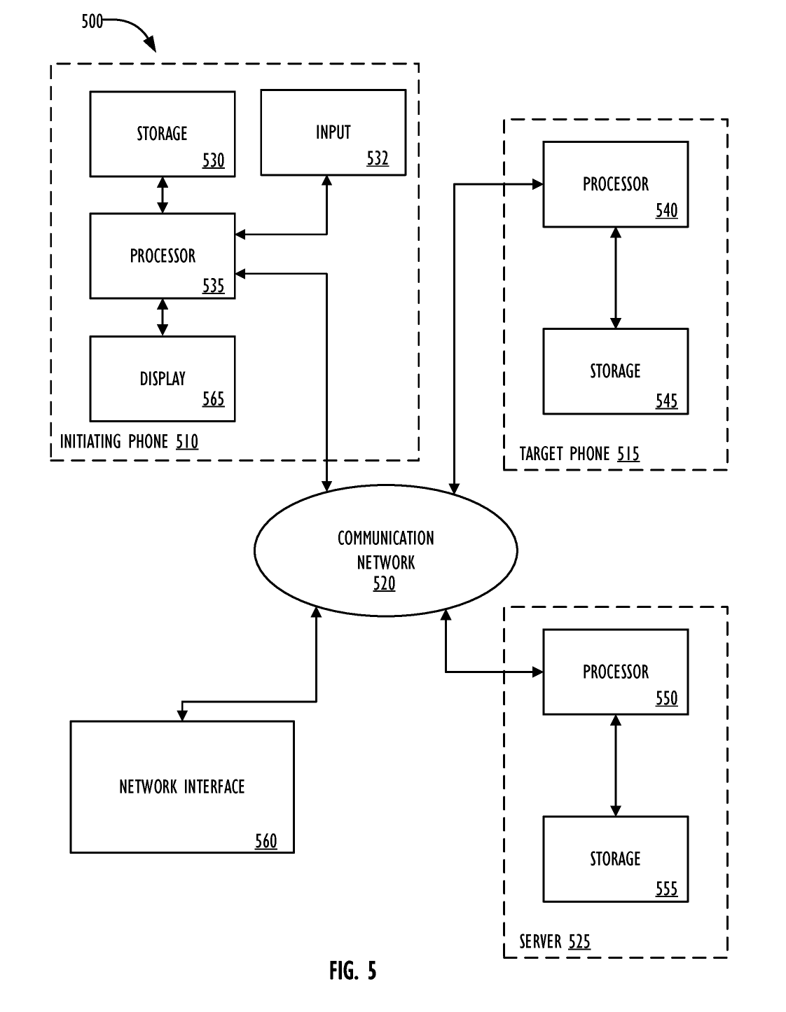

FIG. 5 illustrates a system 500 for customizable presence state-based recipient availability notification, according to an embodiment of the invention. A user desires to make a call from an initiating phone 510 to a target phone 515 via communication network 520, according to an embodiment. Communication network 520 may be a public or private network. In an embodiment, initiating phone 510 includes special features for enabling customizable presence state-based recipient availability notification, according to an embodiment of the invention. For example, initiating phone 510 may include a processor. Initiating phone 510 may also include storage 530. In an embodiment, storage 530 stores instructions to cause the processor 535 to execute one or more of the methods disclosed herein. The initiating phone 510 may also include a display 565 for displaying a notification and an input 532, such as a keyboard, for receiving user inputs and selections. Examples of initiating phone 510 and target phone 515 can include products such as POLYCOM® SoundPoint IP® series, POLYCOM® VVX® series, etc.

Target phone 515 may include a processor 540 and storage 545. In an embodiment, storage 545 stores instructions to cause processor 540 to perform aspects of one or more of the methods disclosed herein. For example, storage 545 may store instructions to enable processor 540 to receive requests for presence state updates and to cause processor 540 to send presence state updates to initiating phone 510 or server 525. System 500 may include a server 525, coupled to the communication network 520. Server 525 may include a processor 550 and storage 555. In another embodiment, storage 555 stores instructions to cause processor 550 to execute one or more of the methods disclosed herein.

System 500 may also include a network interface 560 connecting communication network 520 to one or more additional networks. For example, where communication network 520 is a private office network of telephones, network interface 560 may provide a link to an extra-office network, such as the Internet for VoIP. Network interface 560 may enable communication with a mobile device, whereby a “missed call” notification may be sent, instructions to initiate a call may be received, and a communication link established.

Those skilled in the art will appreciate that various adaptations and modifications can be configured without departing from the scope and spirit of the embodiments described herein. Therefore, it is to be understood that, within the scope of the appended claims, the embodiments of the invention may be practiced other than as specifically described herein.

What is claimed is:

1. A non-transitory program storage device comprising instructions to cause one or more processors to:
receive a call target;
determine an initial presence state of the call target;
initiate a phone call if the initial presence state is an available presence state;
redetermine, if the initial presence state is an unavailable presence state, a current presence state of the call target; and
present, when the presence state has changed from the unavailable presence state to the available presence state, an option to callback the call target.

2. The program storage device of claim 1, further comprising instructions to:
receive a selection of an option to callback the call target.

3. The program storage device of claim 2, further comprising instructions to:
initiate a phone call when the selection indicates a desire to complete the phone call.

4. The program storage device of claim 1, further comprising instructions to:
present, upon determining the initial presence status is the unavailable presence state, an option to provide a callback option; and
receive, prior to presenting an option to callback the call target, selection of a method of providing the callback option.

5. The program storage device of claim 4, wherein a method of providing a callback option comprises sending a missed call to a missed call receiver.

6. The program storage device of claim 5, wherein the instructions further comprise:
receive a number identifying the missed call receiver.

7. The program storage device of claim 1, wherein the instructions to redetermine a current presence state of the call target comprise:
monitor a current presence state of the call target until the current presence state is an available presence state.

8. The program storage device of claim 1, wherein the instructions to redetermine a current presence state of the call target comprise:
request a notification from the call target when a current presence state changes from an unavailable presence state to an available presence state.

9. The program storage device of claim 8, wherein the instructions to redetermine a current presence state of the call target further comprise:
receive a notification from the call target that the target presence state has changed to one of the available presence states.

10. A telephony device comprising:
a connection to a telephony network;
an input to receive inputs and selections from a user;
a display for providing information to a user;
a processor coupled to the connection, the input and the display; and
non-transitory program storage device coupled to the processor and comprising instructions to cause the processor to:
receive a call target;
determine an initial presence state of the call target;
initiate a phone call if the initial presence state is an available presence state;
redetermine, if the initial presence state is an unavailable presence state, a current presence state of the call target; and
present, when the presence state has changed from the unavailable presence state to the available presence state, an option to callback the call target.

11. The telephony device of claim 10, the program storage device further comprising instructions to:
receive a selection of an option to callback the call target.

12. The telephony device of claim 11, the program storage device further comprising instructions to:
initiate a phone call when the selection indicates a desire to complete the phone call.

13. The telephony device of claim 10, the program storage device further comprising instructions to:
present, upon determining the initial presence status is the unavailable presence state, an option to provide a callback option; and
receive, prior to presenting an option to callback the call target, selection of a method of providing the callback option.

14. The telephony device of claim 13, wherein a method of providing a callback option comprises sending a missed call to a missed call receiver.

15. The telephony device of claim 14, the program storage device further comprising instructions to:
receive a number identifying the missed call receiver.

16. The telephony device of claim 10, wherein the instructions to redetermine a current presence state of the call target comprise:
monitor a current presence state of the call target until the current presence state is an available presence state.

17. The telephony device of claim 10, wherein the instructions to redetermine a current presence state of the call target comprise:
request a notification from the call target when a current presence state changes from an unavailable presence state to an available presence state.

18. The telephony device of claim 17, wherein the instructions to redetermine a current presence state of the call target further comprise:
receive a notification from the call target that the target presence state has changed to one of the available presence states.
